(19) United States
(12) Patent Application Publication
(10) Pub. No.: US 2021/0170521 A1
(43) Pub. Date: Jun. 10, 2021

(54) PRODUCTION METHOD OF HEAT TRANSMITTING PLATE

(71) Applicant: NIPPON LIGHT METAL COMPANY, LTD., Tokyo (JP)

(72) Inventors: Hisashi HORI, Shizuoka (JP); Nobushiro SEO, Shizuoka (JP)

(73) Assignee: NIPPON LIGHT METAL COMPANY, LTD., Tokyo (JP)

(21) Appl. No.: 16/772,038

(22) PCT Filed: Jan. 17, 2019
(86) PCT No.: PCT/JP2019/001226

§ 371 Date: Jun. 11, 2020

(30) Foreign Application Priority Data
Apr. 10, 2018 (JP) 2018-075278

(51) Int. Cl. B23K 20/12

(52) U.S. Cl. CPC B23K 20/1255; B23K 2103/10; B23K 20/1265

(57) ABSTRACT

A primary joining rotary tool F comprises a stirring pin F2including a circumferential face tapers to become thinner toward a tip portion of the stirring pin, a flat face F3 at the tip portion of the stirring pin F2 and a projecting portion F4 projecting from the flat face F3. Friction-stirring is performed in the primary joining process by inserting the stirring pin F2 that is rotating into an abutted portion J1 in a manner that only the stirring pin F2 is in contact with the base member 2 and the lid plate 5 with the flat face F3 being in contact with the base member 2 and the lid plate 5 and with a tip face F5 of the projecting portion F4 being in contact only with the base member 2.

### FIELD OF THE INVENTION

The present invention relates to a production method of a heat transmitting plate.

### BACKGROUND ART

Patent Document 1 describes a production method of a heat transmitting plate through which heat exchange is performed by having a fluid flowing through a fluid passage formed inside a base member. The base member has a lid groove formed to open to a front face of the base member and a concave groove formed on a bottom face of the lid groove. When the heat transmitting plate is produced, a lid plate is disposed into the lid groove and friction stir welding is performed on an abutted portion where a side face of the lid plate and a side wall of the lid groove abut each other. When friction stir welding is performed, a stirring pin of a rotary tool is inserted to a deep position in the abutted portion with a bottom face of a shoulder portion of the rotary tool being in contact with the base member and the lid plate. Water tightness and air tightness of the heat transmitting plate are improved by friction-stirring the abutted portion up to a deep position.

On the other hand, Patent Document 2 discloses a production method of a heat transmitting plate in which friction stir welding is performed with only a stirring pin being in contact with the base member and the lid plate.

### PRIOR ART DOCUMENT

### Patent Document

Patent Document 1: JP2002-257490A

Patent Document 2: JP2014-094409A

### SUMMARY OF THE INVENTION

### Objective to be Achieved

A production method of the heat transmitting plate having a higher joint strength has been desired in the technical field as above mentioned.

Taking what is mentioned above into consideration, the inventors have created the present invention to achieve an objective to provide a production method of the heat transmitting plate having a higher joint strength, the production method through which friction stir welding is performed easily at a deep position of the heat transmitting plate.

### Means to Achieve the Objective

In order to achieve the objective, the present invention has a feature of a production method of a heat transmitting plate comprising a lid groove closure process of inserting a lid plate into a lid groove formed around a concave groove and opening to a front face of a base member and a primary joining process of performing friction-stirring by moving a rotary tool provided with a stirring pin along an abutted portion where a side wall of the lid groove and a side face of the lid plate abut each other, wherein the stirring pin of the rotary tool used for the friction-stirring includes a circumferential face that tapers to become thinner toward a tip portion of the stirring pin, a flat face formed at the tip portion of the stirring pin and a projecting portion projecting from the flat face, and wherein in the primary joining process, the stirring pin that is rotating is inserted into the abutted portion and the friction-stirring is performed while only the stirring pin is being in contact with the base member and the lid plate with the flat face being in contact with the base member and the lid plate and with a tip face of the projecting portion being in contact only with the base member.

In addition, the present invention has a feature of a production method of a heat transmitting plate comprising a heat medium pipe insertion process of inserting a heat medium pipe into a concave groove formed on a bottom face of a lid groove that opens to a front face of a base member a lid plate insertion process of inserting a lid plate into the lid groove; and a primary joining process of performing friction-stirring by moving a rotary tool provided with a stirring pin along an abutted portion where a side wall of the lid groove and a side face of the lid plate abut each other, wherein the stirring pin of the rotary tool used for the friction-stirring includes a circumferential face that tapers to become thinner toward a tip portion of the stirring pin, a flat face formed at the tip portion of the stirring pin and a projecting portion projecting from the flat face, and wherein in the primary joining process, the stirring pin that is rotating is inserted into the abutted portion and the friction-stirring is performed while only the stirring pin is being in contact with the base member and the lid plate with the flat face being in contact with the base member and the lid plate and with a tip face of the projecting portion being in contact only with the base member.

According to the methods as described above, only the stirring pin is in contact with the base member and the lid plate. As a result, friction between the rotary tool and the base member and friction between the rotary tool and the lid plate can be reduced and a load applied to a friction stirring device can be reduced. That is, according to the present invention, since the load applied to the friction stirring device can be reduced, friction stir welding can be performed easily on a portion of the abutted portion located at a deep position. Therefore, a fluid passage can be formed easily at a deep position in the heat transmitting plate. In addition, since friction stir welding can be performed on a portion of the abutted portion at the deep position, water tightness and air tightness of the heat transmitting plate is improved. In addition, since the flat face is formed at the tip portion of the stirring pin and the projection portion projecting from the flat face is formed, a plastically flowing material wound up around the projecting portion by the projecting portion is held down by the flat face, which ensures that friction stir welding is performed well around the projecting portion and that oxide films on a bottom face of the lid groove and a back face of the lid plate break. As a result, the joining strength becomes higher.

In addition, a preliminary joining process for preliminarily joining the abutted portion is preferably performed before the primary joining process. According to this production method, a gap can be prevented from being formed in the abutted portion during the primary joining process.

In addition, the present invention has a feature of a production method of a heat transmitting plate comprising a closure process of placing a lid plate on a front face of a base plate to cover a concave groove opening to the front face of the base member; and a primary joining process of inserting a rotary tool provided with a stirring pin from a front face of the lid plate and moving the rotary tool along an overlapped portion where a front face of the base member overlaps with a back face of the lid groove, wherein the stirring pin of the rotary tool used for the friction-stirring includes a circumferential face that tapers to become thinner toward a tip portion of the stirring pin, a flat face formed at the tip portion of the stirring pin and a projecting portion from the flat face, and wherein the friction-stirring is performed on the overlapped portion in the primary joining process while only the stirring pin is being in contact with the base member and the lid plate with the flat face being in contact only with the lid plate and with a tip face of the projecting portion being in contact only with the base member.

In addition, the present invention has a feature of a production method of a heat transmitting plate comprising a closure process of placing a lid plate on a front face of a base plate to cover a concave groove opening to the front face of the base member and a primary joining process of inserting a rotary tool provided with a stirring pin from a back face of the base member and moving the rotary tool along an overlapped portion where a front face of the base member overlaps with a back face of the lid groove, wherein the stirring pin of the rotary tool used for the friction-stirring includes a circumferential face that tapers to become thinner toward a tip portion of the stirring pin, a flat face formed at the tip portion of the stirring pin and a projecting portion from the flat face, and wherein the friction-stirring is performed on the overlapped portion in the primary joining process while only the stirring pin is being in contact with the base member and the lid plate with the flat face being in contact only with the base member and with a tip face of the projecting portion being in contact only with the lid plate.

According to the method, only the stirring pin is in contact with the base member and the lid plate. As a result, friction against the rotary tool can be reduced and a load applied to a friction stirring device can be reduced. That is, according to the present invention, since the load applied to the friction stirring device can be reduced, friction stir welding can be performed easily on the overlapped portion located at a deep position. Therefore, a fluid passage can be formed easily at a deep position of the heat transmitting plate. In addition, since friction stir welding can be performed on a portion of the abutted portion at a deep position, water tightness and air tightness of the heat transmitting plate are improved. In addition, since the flat face is formed at the tip portion of the stirring pin and the projection portion projecting from the flat face is formed, a plastically flowing material wound up around the projecting portion by the projecting portion is held down by the flat face, which ensures that friction stir welding is performed well around the projecting portion and that oxide films on a bottom face of the lid groove and a back face of the lid plate break. As a result, the joining strength becomes higher.

In addition, a preliminary joining process for preliminarily joining the abutted portion is preferably performed before the primary joining process. According to this production method, a gap can be prevented from being formed in the abutted portion during the primary joining process.

In addition, a burr removal process is preferably performed after the primary joining process is finished to remove burrs generated by friction-stirring with the rotary tool. According to this production method, the base member and the lid plate are finished smoothly.

### Effect of the Invention

The production method of the heat transmitting plate of the present invention enables easily friction-stir-welding the abutted portion that is located at a position deep from a surface and improving both water tightness and air tightness.

### BRIEF DESCRIPTION OF THE DRAWINGS

FIG. 1 is a perspective view of a heat transmitting plate of a first embodiment of the present invention.

FIG. 2A is a cross-sectional view showing a preparation process of a production method of the heat transmitting plate of the first embodiment.

FIG. 2B is a cross-sectional view showing a lid groove closure process of the production method of the heat transmitting plate of the first embodiment.

FIG. 3 is a plan view showing a tab member arranging process of the production method of the heat transmitting plate of the first embodiment.

FIG. 4A is a cross-sectional view showing a preliminary joining process of the production method of the heat transmitting plate of the first embodiment.

FIG. 4B is a cross-sectional view showing a primary joining process of the production method of the heat transmitting plate of the first embodiment.

FIG. 5A is a cross-sectional view showing a preparation process of the production method of a heat transmitting plate of a second embodiment of a second embodiment of the present invention.

FIG. 5B is a cross-sectional view showing a lid groove closure process of the production method of the heat transmitting plate of the second embodiment.

FIG. 6 is a cross-sectional view showing a primary joining process of the production method of the heat transmitting plate of the second embodiment.

FIG. 7A is a cross-sectional view showing a preliminary joining process of a production method of a heat transmitting plate of a third embodiment of the present invention.

FIG. 7B is a cross-sectional view showing a primary joining process of the production method of the heat transmitting plate of the third embodiment.

FIG. 8A is a cross-sectional view showing a preliminary joining process of a production method of a heat transmitting plate of a fourth embodiment of the present invention.

FIG. 8B is a cross-sectional view showing a primary joining process of the production method of the heat transmitting plate of the fourth embodiment.

FIG. 9 is a cross-sectional view showing a primary joining process of a production method of a heat transmitting plate of a fifth embodiment.

### DETAILED DESCRIPTION OF THE INVENTION

### First Embodiment

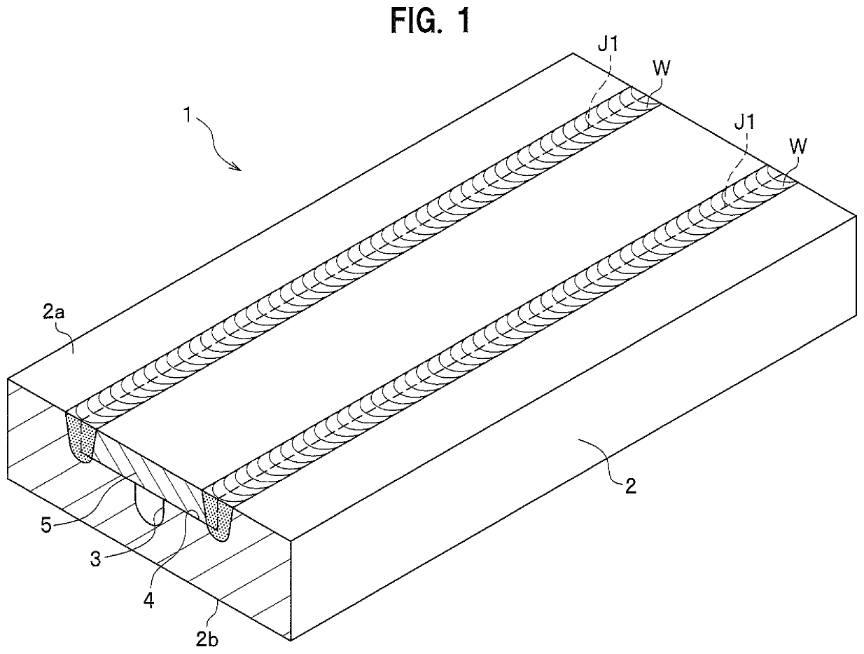

A heat transmitting plate of a first embodiment of the present invention is described below. As shown in FIG. 1, a heat transmitting plate 1 of this embodiment is formed mainly of a base member 2 and a lid plate 5. The base member 2 is generally in a shape of a rectangular parallelepiped. A concave groove 3 and a lid groove 4 are formed on the base member 2. A material of which the base member 2 is made is not limited, may be any material that can be friction-stirred and is an aluminium alloy in this embodiment. “Front face” in this specification denotes a reverse side face of “Back face”.

The concave groove 3 runs through across the base member 2 from one side of the base member 2 to the other side of the base member 2. The concave groove 3 in a concave shape is formed on a bottom face of the lid groove 4. The concave groove 3 has a bottom portion in an arc shape. The concave groove 3 has an opening that opens toward a front face 2a of the base member 2.

The lid groove 4 has a larger width than the concave groove 3 does and is formed on the front face 2a and in communication with the concave groove 3. The lid groove 4 has a cross section in a rectangular shape and opens to the front face 2a.

A lid plate 5 is a plate-like shape member to be inserted into the lid groove 4. The lid plate 5 is formed of an aluminium alloy that is an equivalent material to a material of which the base member 2 is made. The lid plate 5 has the same shape as a cutout portion of the lid groove 4 so that there remains no gap left between the lid groove 4 and the lid plate 5 after the lid plate 5 is inserted into the lid groove 4.

Abutted portions J1, J1 are formed by having a pair of side walls of the lid groove 4 respectively abut a pair of side faces of the lid plate 5. A whole length in the depth direction of each of the abutted portions J1, J1 is friction-stirred and joined. A space enclosed by the concave groove 3 of the heat transmitting plate 1 and a lower face of the lid plate 5 is a passage through which a fluid flows

Next, a production method of the heat transmitting plate of the first embodiment is explained below. A preparation process, a lid groove closure process, a tab member arranging process, a preliminary joining process and a primary joining process are performed in the production process of the heat transmitting plate of the first embodiment.

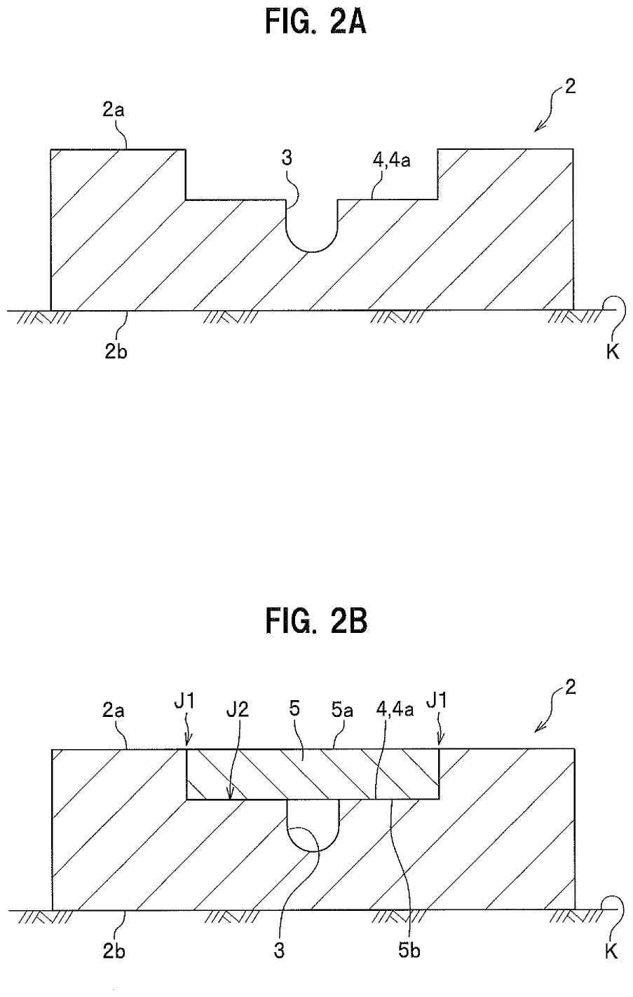

As shown in FIG. 2A, the preparation process is a process in which a base member 2 is prepared. To begin with, the base member 2 is secured to a machine worktable K with a clamp not shown, and the lid groove 4 and the concave groove 3 are formed by cutting work with a tool such as an end mill. The base member 2 with the lid groove 4 and the concave groove 3 formed thereon may be produced by die-casting or extruding.

As shown in FIG. 2B, the lid groove closure process is a process to insert the lid plate 5 into the lid groove 4. The side walls of the lid groove 4 and the side faces of the lid plate 5 respectively abut each other and the abutted portions J1, J1 are formed. In addition, a bottom face 4a of the lid groove 4 abuts a back face 5b of the lid plate 5, and an abutted portion J2 is formed. A front face 5a of the lid plate 5 is flush with the front face 2a of the base member 2.

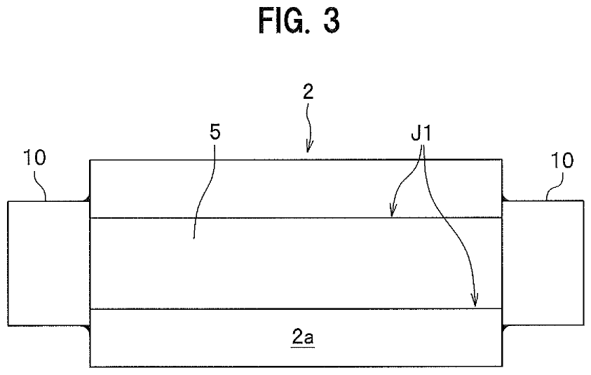

As shown in FIG. 3, the tab member arranging process is a process to arrange tab members 10, 10 on side faces of the base member 2. The tab members 10 are members to set a starting point and an end point of friction-stirring to be described later, The tab members 10 are in face contact with the side faces of the base member 2 that are opposite to each other and are aligned with the abutted portions J1, J1. Each of the tab members 10 is made of an aluminium alloy that is equivalent material to a material the base member 2 is made of. The tab member 10 is joined to the base member 2 by performing welding on corner portions formed between the base member 2 and the tab member 10.

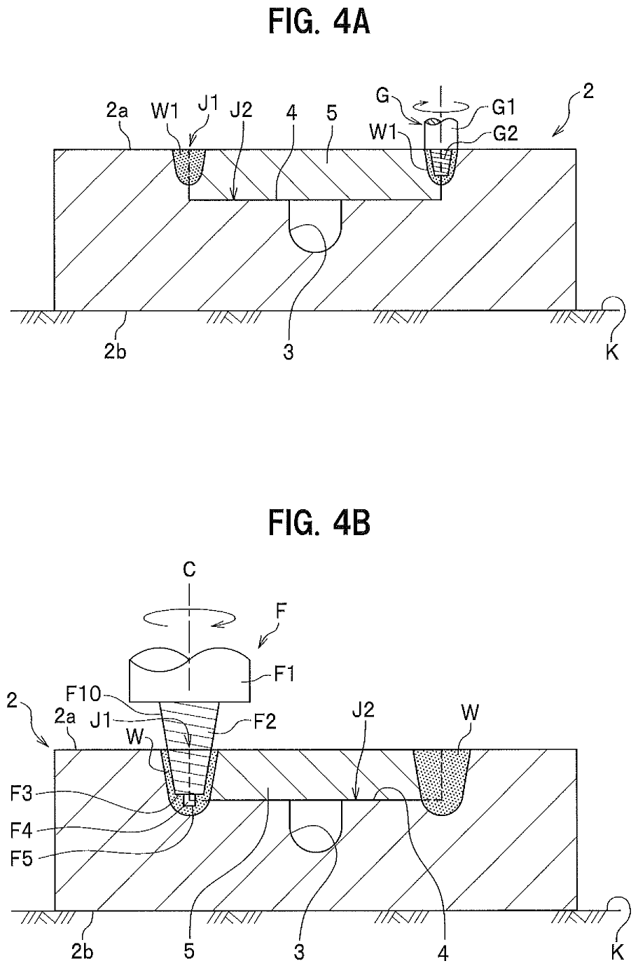

As shown in FIG. 4A, the preliminary joining process is a process to perform friction stir welding as a preliminary joining step on the abutted portions J1, J1 with a preliminary joining rotary tool G. The starting position and the ending position of the preliminary friction stir welding process are not limited, but are set to front faces of the tab members 10 in this embodiment.

To be more specific, the starting position of the preliminary joining process is set to the front face of a first one of the tab members 10, and friction stir welding is performed along the whole length of one of the abutted portions J1, J1.

A plasticized zone W1 is formed along a movement track along which the preliminary joining rotary tool G has moved. After the preliminary joining rotary tool G is moved to a second tab member 10, the preliminary joining rotary tool G is moved turning around on a front face of the second tab member 10 and friction stir welding is performed along the whole length of the other abutted portions J1.

After the preliminary joining rotary tool G is moved back to the first tab member 10, the preliminary joining rotary tool G is removed from the first tab member 10.

As shown in FIG. 4B, the primary joining process is a process to perform friction stir welding on the abutted portions J1, J1 with a primary joining rotary tool (rotary tool) F. The starting position and the ending position of the primary joining process are preferably set to front faces of the tab members 10. When the primary joining rotary tool F is inserted into one of the tab members 10, a removal hole from which the preliminary joining rotary tool G is removed may be used. Otherwise a preliminarily prepared hole may be formed in advance and the primary joining rotary tool F may be inserted through this preliminarily prepared hole.

The primary joining rotary tool F consists of a connecting portion F1 and a stirring pin F2. The primary joining rotary tool F is made, for example, of tool steel. The connecting portion F1 is a portion to be connected with a rotary shaft of a friction-stirring machine (not shown). The connecting portion F1 is in a cylindrical shape and has a threaded hole (not shown) into which a bolt is screwed up.

The stirring pin F2 extends vertically down from and has a common axis with the connecting portion F1. The farther away the stirring pin F2 extends from the connecting portion F1, the thinner the stirring pin F2 is. As shown in FIG. 4B, there is a flat face F3 formed at the tip portion of the stirring pin F2. This flat face F3 is flat and vertical to a rotation axis C of the stirring pin F2. In addition, there is a projecting portion F4 that is formed on the flat face F3 and extends down from the flat face F3. The projecting portion F4 extends from a centre portion of the flat face F3. The projecting portion F4 may have any shape that is not limited and is in a columnar shape in this embodiment.

There is a step portion formed by a side face of the projecting portion F4 and the flat face F3. Accordingly, an outer face of the stirring pin F2 is formed of an outer circumferential face F10 that is tapered toward the tip portion, the flat face F3, an outer circumferential face of the projecting portion F4 and a tip face F5 of the projecting portion F4. There is a spiral groove engraved on the outer circumferential face F10 of the stirring pin F2. Since the primary joining rotary tool F is rotated clockwise in the present embodiment, the spiral groove is formed counterclockwise from a base of the stirring pin F2 to a tip of the stirring pin F2. In other words, if the spiral groove is traced from the base to the tip of the stirring pin F2, the trace is seen spiraling counterclockwise when the stirring pin F2 is viewed from above.

If the primary joining rotary tool F is rotated counterclockwise, the spiral groove is formed preferably clockwise from the base to the tip of the stirring pin F2. In other words, the spiral groove is formed in a manner that if the spiral groove is traced from the base to the tip of the stirring pin F2, the trace is seen clockwise when the spiral groove is viewed from above. When the spiral groove is formed in the manner as described above, plastically flowing metal generated by friction-stirring is moved toward the tip of the stirring pin F2 while friction-stirring is being performed. As a result, an amount of the plastically flowing metal to flow out of metal members to be joined (base member 2 and lid plate 5) can be reduced. It should be noted that a spiral groove may be engraved on a side face of the projecting portion F4.

During the primary joining process, friction stir welding is performed in a manner that the plasticized zone W1 formed in the preliminary joining process is traced. When friction-stirring is performed with the primary joining rotary tool F, only the stirring pin F2 that is rotating clockwise is inserted into the lid plate 5 with the connecting portion F1 being spaced apart from both the base member 2 and the lid plate 5. In other words, while friction-stirring is being performed, a base portion of the stirring pin F2 is exposed. A plasticized zone W is formed along a movement track along which the primary joining rotary tool F has moved after friction-stirred metal hardens.

As shown in FIG. 4B, friction-stirring in the primary joining process is performed with the flat face F3 of the stirring pin F2 being in contact with both the base member 2 and the lid plate 5 and with the tip face F5 of the projecting portion F4 being in contact only with the base member 2. In other words, an insertion depth of the stirring pin F2 in the primary joining process is set to such a depth that a side face of the projecting portion F4 is positioned across the abutted portion J2.

A burr removing process in which burrs made by friction-stirring is removed may be performed after the primary joining process. The front faces of the base member 2 and the lid plate 5 can be made smooth by performing the burr removing process.

According to the production method of the heat transmitting plate of the present embodiment as has been explained, only the stirring pin F2 out of the primary joining rotary tool F is in contact with the base member 2 and the lid plate 5 when the primary joining process is performed. As a result, friction between the primary joining rotary tool F and the base member 2 and friction between the primary joining rotary tool F and the lid plate 5 can be reduced and a load to be applied to the friction stirring device can be reduced. Accordingly, since the load to be applied to the friction stirring device is made smaller in the present embodiment if friction-stirring is performed on a portion at a deeper position, the fluid passage can be easily made at a deeper position in the heat transmitting plate 1.

In addition, although friction-stirring need not be performed over the whole length in the depth direction of each of the abutted portions J1, J1, both water tightness and air tightness of the heat transmitting plate 1 can be improved if friction-stirring is performed over the whole length in the depth direction of each of the abutted portions J1, J1 like the present embodiment.

In addition, since the projecting portion F4 is formed on the flat face F3 at the tip portion of the stirring pin F2, the plastically flowing material made by friction-stirring around the projecting portion F4 is wound up by the projecting portion F4. However, the plastically flowing material that is wound up is held down by the flat face F3, which ensures that friction-stirring is performed sufficiently around the projecting portion F4 and that oxide films along the abutted portion J2 is reliably broken. As a result, a joint strength of the abutted portion J2 is enhanced.

In addition, a gap between the base member 2 and the lid plate 5 is prevented from being formed during the primary joining process by performing the preliminary friction-stirring.

In the preliminary joining process, friction-stirring with the preliminary joining rotary tool G may be performed discontinuously to form along the abutted portion plural discrete plasticized zones W1 that are separated from one another. In addition, in the preliminary joining process, each of the abutted portions J1, J1 may be joined by welding. In addition, each of the tab members 10 may be provisionally joined to the base member 2 with the preliminary joining rotary tool G.

### Second Embodiment

Next, a second embodiment of the present invention is explained. A heat transmitting plate of the second embodiment differs from the first embodiment in that the heat transmitting plate is fitted with a heat medium pipe 6. The heat medium pipe 6 has an inside through which a fluid flows.

A preparation process, a heat medium pipe insertion process, a lid groove closure process, a preliminary joining process and a primary joining process are performed in a production method of the heat transmitting plate of the second embodiment.

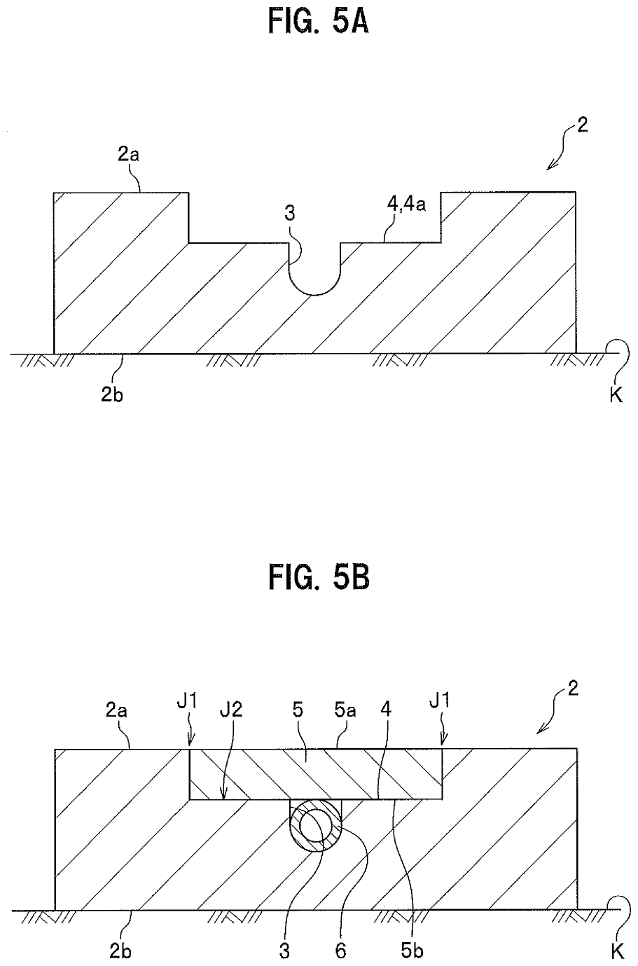

As shown in FIG. 5A, the preparation process is a process in which the base member 2 is prepared.

As shown in FIG. 5B, the heat medium pipe insertion process is a process in which the heat medium pipe 6 is inserted into the concave groove 3. Sizes of the concave groove 3 and the heat medium pipe 6 may be appropriately determined. In the second embodiment, an outer diameter of the heat medium pipe 6 is set equal to a width and a depth of the concave groove 3.

The lid groove closure process (lid plate insertion process) is a process in which the lid plate 5 is inserted into the lid groove 4. The abutted portions J1, J1 are formed by having a pair of side walls of the lid groove 4 respectively abut a pair of the side faces of the lid plate 5. By inserting the lid plate 5 into the lid groove 4, the heat medium pipe 6 and the lid plate 5 are made to be in contact each other and the front face 2a of the base member 2 is flush with the front face 5a of the lid plate 5.

The preliminary joining process is a process in which the abutted portion J1 is preliminarily joined. The preliminary joining process is performed in the same way as performed in the first embodiment.

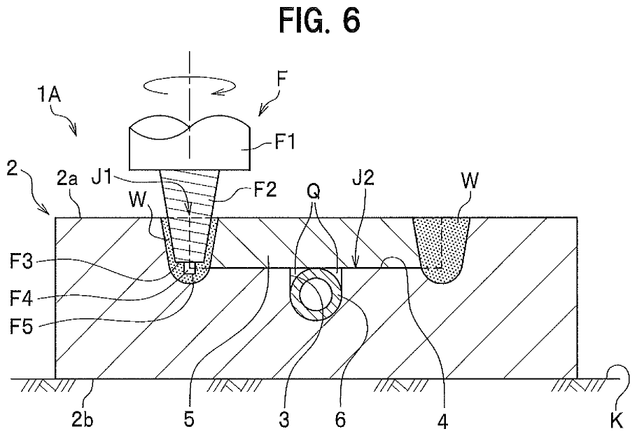

As shown in FIG. 6, the primary joining process is a process in which friction stir welding is performed on the abutted portions J1, J1 with the primary joining rotary tool F. The primary joining process is performed in the same way as performed in the first embodiment. Plasticized zones W, W are formed along a movement track along which the primary joining rotary tool F has moved. The plasticized zone W is formed over a whole length in the depth direction of each of the abutted portions J1, J1.

The production method of the heat transmitting plate according to the second embodiment brings about more or less the same effect as the first embodiment and enables easily producing the heat transmitting plate 1A fitted with the heat medium pipe 6.

In addition, for instance, the shapes of the concave groove 3, the lid groove 4, the lid plate 5 and the heat medium pipe 6 as described for the first and second embodiments are exemplary ones and other shapes may be adopted.

In addition, in case there is a step formed between the front face 2a of the base member 2 and a surface of the plasticized zone W, build-up welding is performed on the step to fill the step. Otherwise, a metal plate may be placed on the surface of the plasticized zone W, and the metal plate and the base member 2 may be joined by friction stir welding with a rotary tool.

In addition, this embodiment shows a case in which the lid groove 4 is formed. However, the lid plate 5 may be directly inserted into the concave groove 3 without forming the lid groove 4.

In addition, if a gap Q is formed around the heat medium pipe 6 as shown in FIG. 6, the gap Q may be filled through the primary joining process. When the lid plate 5 is inserted into the lid groove 4 in the lid groove closure process, the gap Q defined by the concave groove 3, a lower face of the lid plate 5 and the heat medium pipe 6 is formed. In the primary joining process, the plastically flowing material produced by the primary joining rotary tool F can be made to flow into the gap Q, which results in the gap Q around the heat medium pipe 6 being filled with metal to improve water tightness and air tightness.

### Third Embodiment

Next a third embodiment of the present invention is explained. A production method of a heat transmitting plate of the third embodiment differs from the first embodiment in that there is no lid groove 4 formed on the base member 2 and in that the lid plate 5 is placed on the front face 2a of the base member 2.

A preparation process, a concave groove closure process, a preliminary joining process and a primary joining process are performed in the production method of a heat transmitting plate of the third embodiment.

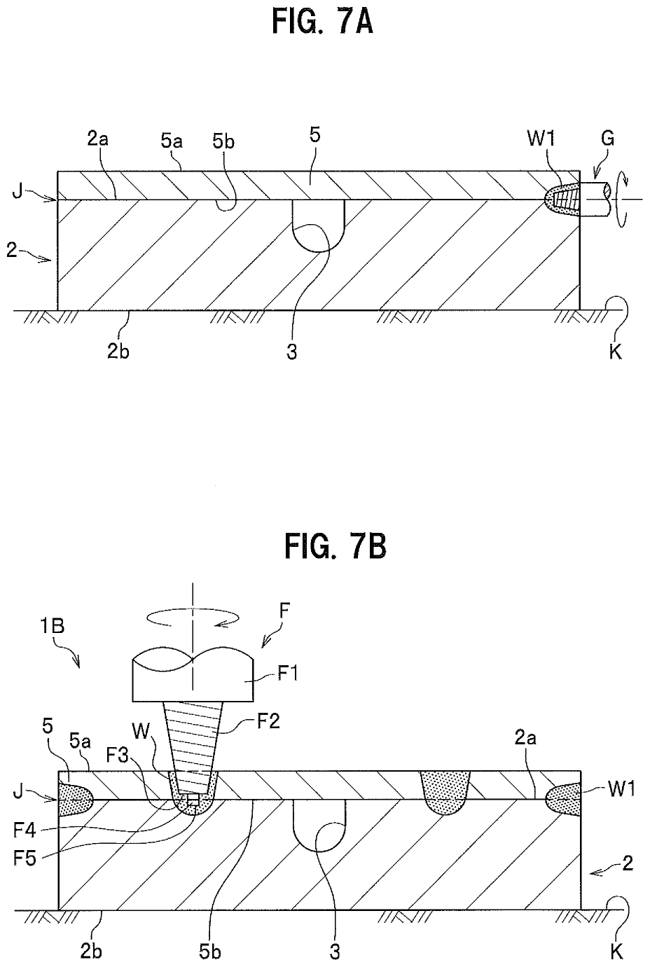

As shown in FIG. 7A, the preparation process is a process to prepare a base member 2. A concave groove 3 is formed on the front face 2a of the base member 2.

The concave groove closure process (closure process) is a process to place the lid plate 5 on the front face 2a of the base member 2 to cover an upper opening of the concave groove 3. An overlapped portion J is formed in the concave groove closure process by overlapping the front face 2a of the base member 2 with a back face 5b of the lid plate 5.

The preliminary joining process is a process to preliminarily join the overlapped portion J. Friction stir welding is performed on the overlapped portion J by inserting the preliminary joining rotary tool G into the overlapped portion J from sides of the base member 2 and the lid plate 5 in the preliminary joining process of this embodiment. After the preliminary joining process, there is a plasticized zone W1 formed along the sides of the base member 2 and the lid plate 5.

As shown in FIG. 7B, the primary joining process is a process to perform friction stir welding on the overlapped portion J with the primary joining rotary tool F. In this embodiment, only the stirring pin F2 is inserted vertically into the lid plate 5 from the front face 2a of the lid plate 5 and friction-stirring is performed with the connecting portion F1 being spaced apart from the lid plate 5.

In addition, friction-stirring is performed in this primary joining process with the flat face F3 of the stirring pin F2 being in contact only with the lid plate 5 and with the tip face F5 of the projecting portion F4 being in contact only with the base member 2. In other words, an insertion depth of the stirring pin F2 in this primary joining process is set to such a depth that the side face of the projecting portion F4 is positioned across the overlapped portion J. The base member 2 and the lid plate 5 are joined together and thus a heat transmitting plate 1B is formed.

As described, according the production method of the heat transmitting plate of the third embodiment, the heat transmitting plate 1B can be easily produced with the lid plate 5 placed on the front face 2a of the base member 2 and without the lid groove 4 being formed. That is, although the overlapped portion J is positioned at a deep position in the third embodiment, friction between the primary joining rotary tool F and the base member 2 and friction between the primary joining rotary tool F and the lid plate 5 are reduced by only the stirring pin F2 being made to be in contact with the base member 2 and the lid plate 5. Thus, a load to be applied to the friction stirring device can be made small. Accordingly, since the load to be applied to the friction stirring device can be made small even when friction-stirring is performed at a deep position, a fluid passage can be easily formed at the deep position in the heat transmitting plate 1B.

In addition, since the projecting portion F4 is formed to extend from the flat face F3 at the tip portion of the stirring pin F2, the plastically flowing material that is friction-stirred around the projecting portion F4 and wound up by the projecting portion F4 is held down by the flat face F3, which ensures that friction-stirring is performed sufficiently around the projecting portion F4 and that the oxide films along the overlapped portion J is reliably broken. As a result, a joining strength at the overlapped portion J becomes higher. Furthermore, performing the preliminary joining process prevents a gap between the base member 2 and the lid plate 5 from being formed during the primary joining process.

In addition, friction-stirring with the preliminary joining rotary tool G may be performed discontinuously to form along the overlapped portion plural discrete plasticized zones W1 that are separated from one another in the preliminary joining process. In addition, in the preliminary joining process, the overlapped portion J may be joined by welding. In addition, the preliminary joining process and the primary joining process may be performed using the tab members in the same way as performed in the first embodiment.

In the primary joining process, the primary joining rotary tool F may be inserted into the base member 2 from the back face 2b of the base member 2 and friction stir welding may be performed on overlapped portion J in the same way as performed in this embodiment already explained. When the primary joining process is performed in this way, friction stir welding is performed on the overlapped portion J with the flat face F3 being in contact only with the base member 2 and with the tip face F5 of the projecting portion F4 being in contact with the lid plate 5.

### Fourth Embodiment

Next a fourth embodiment of the present invention is described. A production method of a heat transmitting plate of the fourth embodiment differs from the third embodiment in that a concave portion 20 having a larger recess is formed.

A preparation process, a concave portion closure process, a preliminary joining process and a primary joining process are performed in the production process of a heat transmitting plate of the fourth embodiment.

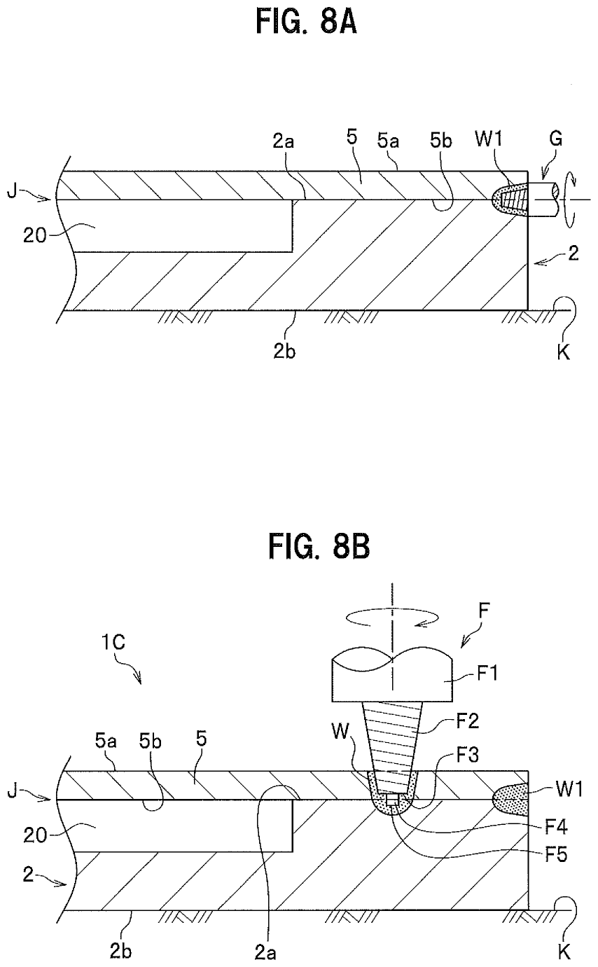

As shown in FIG. 8A, the preparation process is a process to prepare a base member 2. The concave portion 20 is formed on the front face 2a of the base member 2. The concave portion 20 is a much larger recess than the concave groove 3.

The concave portion closure process (closure process) is a process to place the lid plate 5 on the front face 2a of the base member 2 to cover an upper opening of the base member 2. The front face 2a of the base member 2 is overlapped with the back face 5b of the lid plate 5 to form an overlapped portion J. As shown in FIG. 8B, the preliminary joining process and the primary joining process are equivalent to those in the third embodiment and their detailed description is omitted. After these processes, a heat transmitting plate 1C is formed.

The production method of the heat transmitting plate of the fourth embodiment has the same effect as the third embodiment does. In addition, the fourth embodiment enables easily producing the heat transmitting plate 1C even when the lid plate 5 having a larger thickness is placed over the concave portion 20 being larger than the concave groove 3. In addition, the primary joining rotary tool F may be inserted from the back face 2b of the base member 2 in the primary joining process and friction stir welding is performed on the overlapped portion J in the same way as done in this embodiment.

### Fifth Embodiment

Next, a friction stir welding method of a fifth embodiment of the present invention is described. The fifth embodiment differs from the other embodiments in that metal members without any fluid passage such as the concave groove 3 or the concave portion 20 formed therein are joined together.

There are a preparation process, an overlapping process, a preliminary joining process and a primary joining process to be performed in the friction stir welding method of the fifth embodiment.

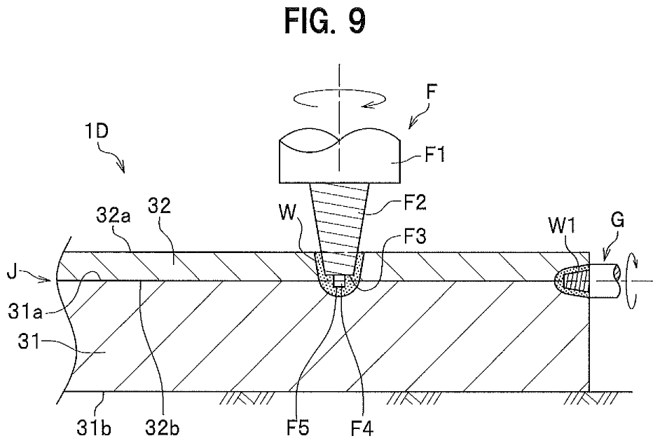

As shown in FIG. 9, the preparation process is a process to prepare metal members 31, 32. The metal members 31, 32 are both plate-like members. The metal members 31, 32 may be of any kind of metal that can be friction-stirred.

The overlapping process is a process to overlap the metal members 31,32 with each other. An overlapped portion J is formed by having a front face 31a of the metal member 31 and a back face 32b of the metal member overlap with each other.

The preliminary joining process is a process to preliminarily join the overlapped portion J. Friction stir welding is performed on the overlapped portion J by inserting the preliminary joining rotary tool G into the overlapped portion J from sides of the metal members 31, 32 in the preliminary joining process of this embodiment. After the preliminary joining process is finished, there is a plasticized zone W1 formed along the sides of the metal members 31, 32.

The primary joining process is a process to perform friction stir welding on the overlapped portion J with the primary joining rotary tool F. In this embodiment, only the stirring pin F2 of the primary joining rotary tool F is inserted vertically into the metal member 32 from the front face 32a of the metal member 32 and friction-stirring is performed with the connecting portion F1 being spaced apart from the metal member 32.

In addition, friction-stirring is performed in this primary joining process with the flat face F3 of the stirring pin F2 being in contact only with the metal member 32 and with the tip face F5 of the projecting portion F4 being in contact only with the metal member 31. In other words, an insertion depth of the stirring pin F2 in this primary joining process is set to such a depth that the side face of the projecting portion F4 is positioned across the overlapped portion J. The metal members 31, 32 are joined together and thus a stacked plate 1D is formed.

According to the production method of the heat transmitting plate of the fifth embodiment, a stacked plate 1D without a fluid passage formed therein can be produced easily. Especially, since only the stirring pin F2 is in contact with the metal members 31, 32, friction between the metal members 31, 32 and the primary joining rotary tool F is reduced and thus a load applied to the friction stirring device is reduced even when the overlapped portion J is positioned at a deep position with the metal member 32 having a larger thickness. Accordingly, friction stir welding is easily performed even with the overlapped portion J positioned at a deep position.

Since the projecting portion F4 is formed to extend from the flat face F3 at the tip portion of the stirring pin F2, the plastically flowing material that is friction-stirred around the projecting portion F4 and wound up by the projecting portion F4 is held down by the flat face F3, which ensures that friction-stirring is performed sufficiently around the projecting portion F4 and that the oxide films along the overlapped portion J are reliably broken. As a result, a joining strength at the overlapped portion J becomes higher.

Furthermore, performing the preliminary joining process prevents a gap between the metal members 31, 32 from being formed during the primary joining process.

In addition, friction-stirring with the preliminary joining rotary tool G may be performed discontinuously to form along the overlapped portion plural discrete plasticized zones W1 that are separated from one another in the preliminary joining process.

In addition, in the preliminary joining process, the overlapped portion J may be joined by welding. In addition, the preliminary joining process and the primary joining process are performed using the tab members as used in the first embodiment.

In addition, the primary joining rotary tool F may be inserted from the back face 31b of the metal member 31 and friction stir welding is performed on the overlapped portion J in the same way as done in this embodiment. In this case, friction-stirring is performed on the overlapped portion J with the flat face F3 being in contact only with the metal member 31 and with a tip face F5 of the projecting portion F4 being in contact with the metal member 32 in the primary joining process.

In addition, the burr removal process to remove burrs formed by friction-stirring may be performed in any of the second to fifth embodiments.

### DESCRIPTION OF SIGNS

1 Heat transmitting plate
2 Base member
3 Concave groove
4 Lid groove
5 Lid plate
6 Heat medium pipe
10 Tab member
20 Concave portion
31 Metal member
32 Metal member
F Primary joining rotary tool (Rotary tool)
F2 Stirring pin
G Preliminary joining rotary tool
J1 Abutted portion
J2 Abutted portion
J Overlapped portion
W Plasticized portion

1. A production method of a heat transmitting plate comprising:
a lid groove closure process of inserting a lid plate into a lid groove formed around a concave groove and opening to a front face of a base member; and
a primary joining process of performing friction-stirring by moving a rotary tool provided with a stirring pin along an abutted portion where a side wall of the lid groove and a side face of the lid plate abut each other,
wherein the stirring pin of the rotary tool used for the friction-stirring includes a circumferential face that tapers to become thinner toward a tip portion of the stirring pin, a flat face formed at the tip portion of the stirring pin and a projecting portion projecting from the flat face, and
wherein in the primary joining process, the stirring pin that is rotating is inserted into the abutted portion and the friction-stirring is performed while only the stirring pin is being in contact with the base member and the lid plate with the flat face being in contact with the base member and the lid plate and with a tip face of the projecting portion being in contact only with the base member.

2. A production method of a heat transmitting plate comprising:
a heat medium pipe insertion process of inserting a heat medium pipe into a concave groove formed on a bottom face of a lid groove that opens to a front face of a base member;
a lid plate insertion process of inserting a lid plate into the lid groove; and
a primary joining process of performing friction-stirring by moving a rotary tool provided with a stirring pin along an abutted portion where a side wall of the lid groove and a side face of the lid plate abut each other,
wherein the stirring pin of the rotary tool used for the friction-stirring includes a circumferential face that tapers to become thinner toward a tip portion of the stirring pin, a flat face formed at the tip portion of the stirring pin and a projecting portion projecting from the flat face, and
wherein in the primary joining process, the stirring pin that is rotating is inserted into the abutted portion and the friction-stirring is performed while only the stirring pin is being in contact with the base member and the lid plate with the flat face being in contact with the base member and the lid plate and with a tip face of the projecting portion being in contact only with the base member.

3. The production method of a heat transmitting plate as claimed in claim 1, further comprising a preliminary joining process for preliminarily joining the abutted portion before the primary joining process.

4. A production method of a heat transmitting plate comprising:
a closure process of placing a lid plate on a front face of a base plate to cover a concave groove opening to the front face of the base member; and
a primary joining process of inserting a rotary tool provided with a stirring pin from a front face of the lid plate and moving the rotary tool along an overlapped portion where a front face of the base member overlaps with a back face of the lid groove,
wherein the stirring pin of the rotary tool used for the friction-stirring includes a circumferential face that tapers to become thinner toward a tip portion of the stirring pin, a flat face formed at the tip portion of the stirring pin and a projecting portion from the flat face, and
wherein the friction-stirring is performed on the overlapped portion in the primary joining process while only the stirring pin is being in contact with the base member and the lid plate with the flat face being in contact only with the lid plate and with a tip face of the projecting portion being in contact only with the base member.

5. A production method of a heat transmitting plate comprising:
a closure process of placing a lid plate on a front face of a base plate to cover a concave groove opening to the front face of the base member; and
a primary joining process of inserting a rotary tool provided with a stirring pin from a back face of the base member and moving the rotary tool along an overlapped portion where a front face of the base member overlaps with a back face of the lid groove,
wherein the stirring pin of the rotary tool used for the friction-stirring includes a circumferential face that tapers to become thinner toward a tip portion of the stirring pin, a flat face formed at the tip portion of the stirring pin and a projecting portion from the flat face, and
wherein the friction-stirring is performed on the overlapped portion in the primary joining process while only the stirring pin is being in contact with the base member and the lid plate with the flat face being in contact only with the base member and with a tip face of the projecting portion being in contact only with the lid plate.

6. The production method of a heat transmitting plate as claimed in claim 4, further comprising a preliminary joining process for preliminarily joining the abutted portion before the primary joining process.

7. The production method of a heat transmitting plate as claimed in claim 1, further comprising a burr removing process of removing burrs formed by the friction-stirring with the rotary tool after the primary joining process is finished.

8. The production method of a heat transmitting plate as claimed in claim 2, further comprising a preliminary joining process for preliminarily joining the abutted portion before the primary joining process.

9. The production method of a heat transmitting plate as claimed in claim 5, further comprising a preliminary joining process for preliminarily joining the abutted portion before the primary joining process.

10. The production method of a heat transmitting plate as claimed in claim 2, further comprising a burr removing process of removing burrs formed by the friction-stirring with the rotary tool after the primary joining process is finished.

11. The production method of a heat transmitting plate as claimed in claim 4, further comprising a burr removing process of removing burrs formed by the friction-stirring with the rotary tool after the primary joining process is finished.

12. The production method of a heat transmitting plate as claimed in claim 5, further comprising a burr removing process of removing burrs formed by the friction-stirring with the rotary tool after the primary joining process is finished.
